(19) United States
(12) Patent Application Publication
(10) Pub. No.: US 2009/0056131 A1
(43) Pub. Date: Mar. 5, 2009

(54) Equipment and Method for Making a Needle-Fin Tube, and a Needle-Fin Tube

(75) Inventor: Risto Castren, Lahti (FI)

Correspondence Address: STIENNON & STIENNON, 612 W. MAIN ST., SUITE 201, P.O. BOX 1667, MADISON, WI, 53701-1667, US

(73) Assignee: RETERMIA OY, Heinola (FI)

(21) Appl. No.: 12/200,605

(22) Filed: Aug. 28, 2008

(30) Foreign Application Priority Data
Aug. 31, 2007 (FI) 20075602

(51) Int. Cl. B23P 15/26

(52) U.S. Cl. 29/890.046; 29/727

(57) ABSTRACT

A method and equipment for making a needle-fin tube having needle-like external fin parts, and internal fin structure formed by a spiraled spring wire which expands to clamp again the tube in the needle-fin tubes. The wire used to form the internal fin is wound along and around a bar which is moved and rotated along a straight line. The bar is moved inside the needle-fin tube from its one end to the other and the wire is released from the bar to attach to the internal surface of the needle-fin tube under spring force.

### CROSS REFERENCES TO RELATED APPLICATIONS

This application claims priority on Finnish App. No. 20075602, filed Aug. 31, 2007, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention concerns equipment and a method for making a needle-fin tube, and a needle-fin tube.

It is characteristic of indirect heat transfer and cooling systems that the operating temperature of the liquid circulating in the liquid circulation network will drop below zero Celsius degrees. A mixture of water and some agent preventing the water from freezing is hereby often used as the heat carrier liquid. Mono-ethylene glycol and mono-propylene glycol are the anti-freeze agents most frequently used. With an increasing content of anti-freeze agent and a lowering temperature, the flow in the smooth tube will easily be laminar, whereby the heat transfer coefficient between the liquid and the tube surface is low and the thermal resistance is hereby high. As a result of this the value of the heat delivery surface's coefficient of thermal transmittance remains small, which can be compensated for by increasing the heat delivery surface area or, on the other hand, steps can be taken to improve the value of the heat transfer coefficient of the liquid side.

As a solution to improve the heat transfer coefficient of the liquid side a turbulator wire is used, which is installed inside the tube (a passive method for boosting the heat transfer), owing to which the flow is made turbulent even at low flow velocity values, and the heat transfer is thus made more efficient.

### SUMMARY OF THE INVENTION

The present application presents a method and equipment with which a needle-fin tube can be finned industrially and quickly on the inside with a separate wire. Said turbulence wire is brought in contact with the internal surface of the needle-fin tube, whereby it is released to said surface and it attaches to this by its own tension and spring force. No kinds of attaching means, glues or other means are required.

In the early stage of feeding, a transfer unit brings the tubes to a so-called turbulator machine, that is, a wiring machine. A wire-feeding unit for its part moves the wire to a lower position and brings the wire along when descending. A separate cylinder of a support lever or support rod moves the support lever to a so-called internal station to support the needle tube. A feeding bar (“rassi”) then moves forward, so that the wire will move to the bottom of a V-shaped opening in the end of the feeding bar. The bar is then being rotated in a clockwise direction, whereby the wire will attach to the groove in the end of the opening in the bar.

A low feeding speed is used to begin with, to do a few turns of wire at a closer pitch, whereby a support surface is formed at the end of the feeding bar. In this manner the end of the feeding bar is prevented from scratching the tube's internal surface and its guiding is supported, should there be variations in the straightness in the needle tube.

The feeding speed is then increased to be suitable for the desired pitch of the turbulator wire or fin wire, whereby the feeding bar will enter the needle tube. At the same time, the speed of rotation of the feeding bar is kept at its desired value.

The fin wire traveling from a reel travels through a wire brake, which is located in the wire-feeding unit and which can be used to keep the wire under a suitable tension. The tube transfer unit is intended to hold the tube, whereby the tube is prevented from rotating during the wiring.

The present application uses a separate feeding bar (a so-called “rassi”) moved by a cylinder device actuator and comprising an end notch for attaching a wire to the end of the feeding bar. Said notch is preferably a so-called V notch. The actuator brings the wire into said notch, whereupon the bar is first rotated with a small pitch and at a low speed of rotation, and the rotation speed and pitch are then increased according to the requirement of each finned tube. As the wire is thus attached to the rotated bar or feeding bar, the rotation is continued in a clockwise direction and the finned tube is supported at the same time to prevent it from rotating. While rotating the feeding bar, the actuator is used to move the feeding bar in a linear manner inside the finned tube. When the feeding bar has been fed out of the end of the finned tube, a photo cell will detect the arrival of the feeding bar at the end station. The feeding out of the bar then stops and the bar is rotated in place for a few revolutions, for example, five revolutions, whereby the wire will come off the groove in the end of the bar. According to the invention, as the feeding bar reaches the final end of the needle tube in the manner described above, a photo cell identifies the feeding bar, whereby after a programmed distance the feeding and rotation will stop. A separate cutter will hereby cut the wire and the wire feeding unit will rise up bringing the wire along. The bar can then be removed from inside the needle-fin tube and the tube which has been thus finned inside can be delivered to further treatment.

As the wire is removed from the feeding bar, the feeding bar is rotated in place in a counter-clockwise direction for a few revolutions, whereby the wire will come off the end of the feeding bar. Under continued rotation the feeding bar is pulled out from inside the tube. When the feeding bar has been pulled entirely out from inside the tube, the cylinder will push the support lever back into the outer position to once again support the wire feeding stage. At this stage, the tube transfer unit moves the tubes to further treatment. The wire has a certain pitch and the wire has a circular cross-section and it is preferably made of metal.

The invention will be described in the following by referring to the figures in the appended drawings and to the advantageous embodiments shown in the figures, but there is no intention to restrict the invention to these embodiments only.

### BRIEF DESCRIPTION OF THE DRAWINGS

FIG. 1A illustrates the equipment according to the invention for making a fin brought inside a tube for a heat transfer agent in a spiral internal needle-fin tube and for attaching it to the inside surface of the tube. The presentation in FIG. 1A is illustrating.

FIG. 1B illustrates a body R₁, which is moved on guide bars with the aid of a motor and which body comprises rotating equipment for a bar or feeding bar.

FIG. 1C illustrates rotation with the aid of the same toothed belt or other such of bars located beside one another.

FIG. 1D illustrates guiding of a wire to the end of a bar.

FIG. 1E shows a view from above of a support rod used for guiding the wire.

FIG. 2A shows a flexible supporting part located in the support rod, with the aid of which supporting part the tube to be finned can be kept in place as the spiral fin-making is taking place on the bar.

FIG. 2B is a view in principle of a wire brake.

FIG. 2C is a view in principle of a wire-cutting device.

FIG. 2D shows a device for moving finned tubes, which is also used for holding the finned tube during the formation of the spiral internal fin for the heat carrier.

FIG. 3A shows a wall structure formed of a needle-fin tube.

FIG. 3B is a cross-sectional view along line III-III of FIG. 3A.

FIG. 3C is a cross-sectional view along line IV-IV of FIG. 3B.

FIG. 3D shows the fin tube structure of FIG. 3C in the direction of arrow K₁ in FIG. 3C.

FIG. 3E shows a wall structure formed of fin tubes in between manifolds J₁ and J₂.

FIG. 4A shows a counter part, which is located at an early stage of the fin making and which is used to support the transfer of the wire into a notch in one end of the bar at the early stage of fin making.

FIG. 4B shows the stage of FIG. 4A from a different direction in order to show the structures.

FIG. 4C shows the arrival of the wire from the end of the feeding bar before the wire is released to the internal walls of the heat carrier tube under the wire's spring force.

### DESCRIPTION OF THE PREFERRED EMBODIMENTS

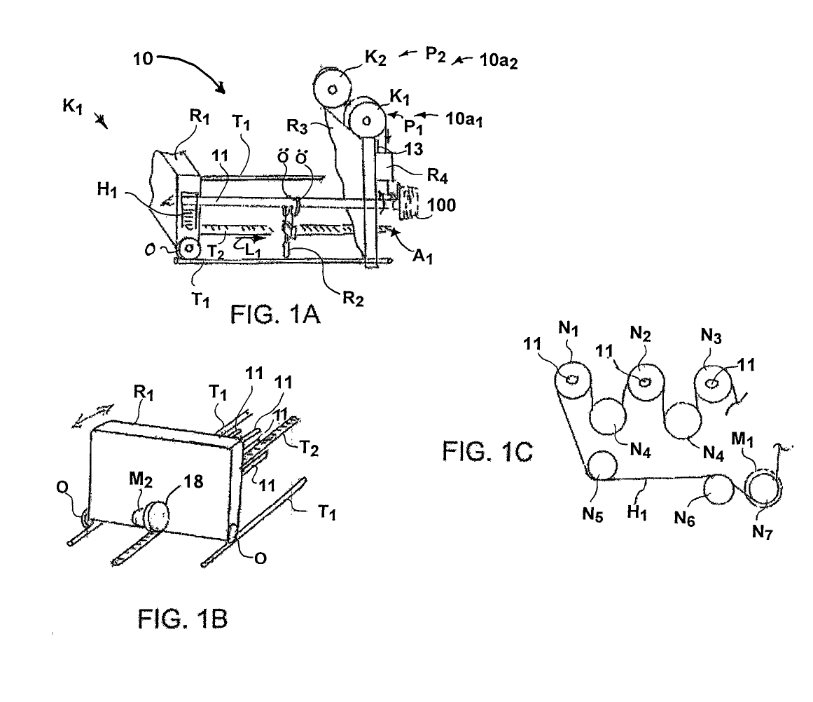

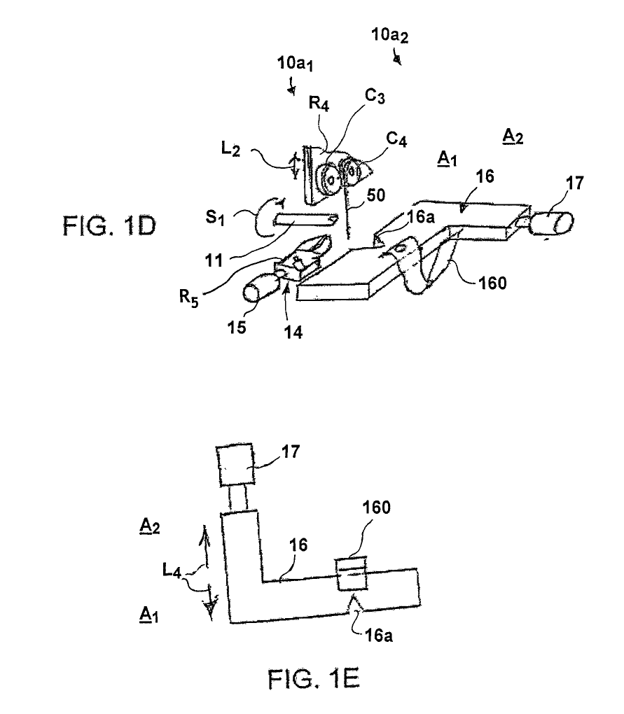

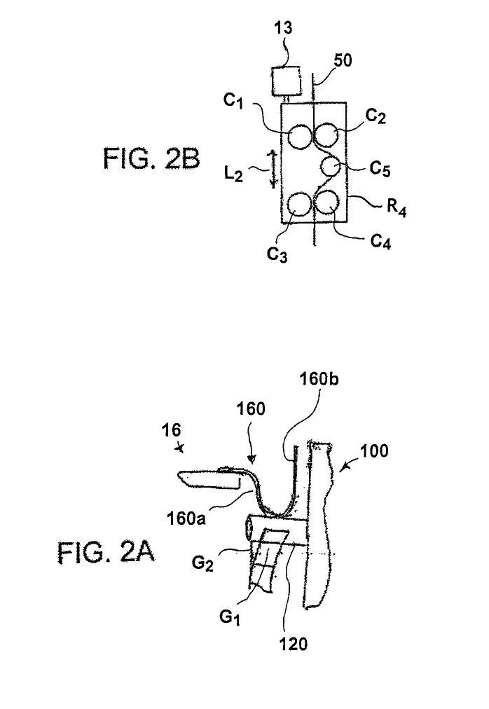

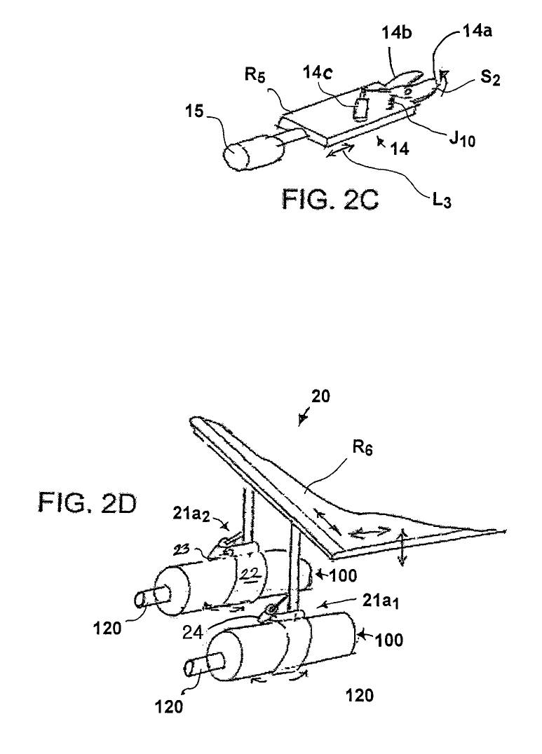

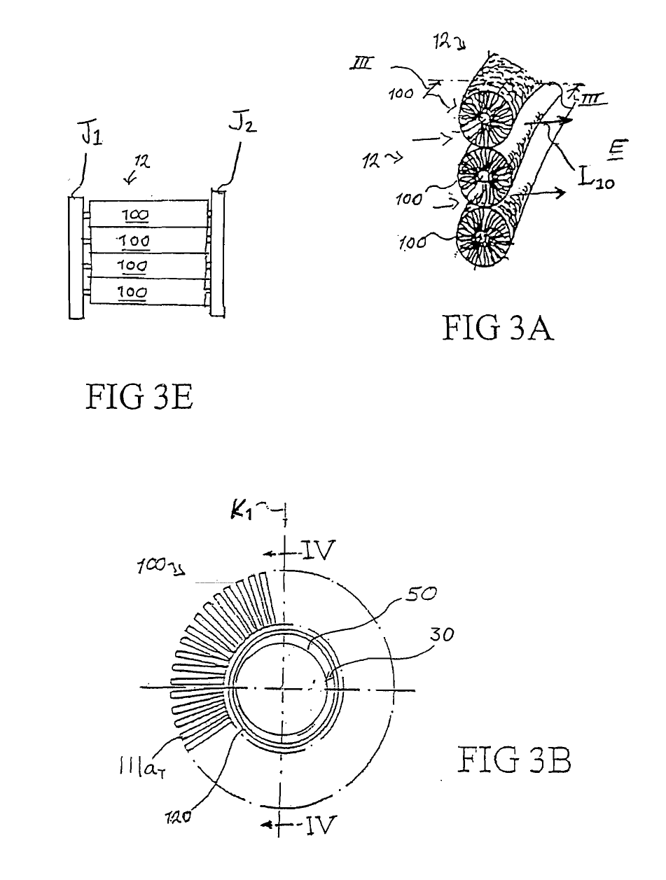

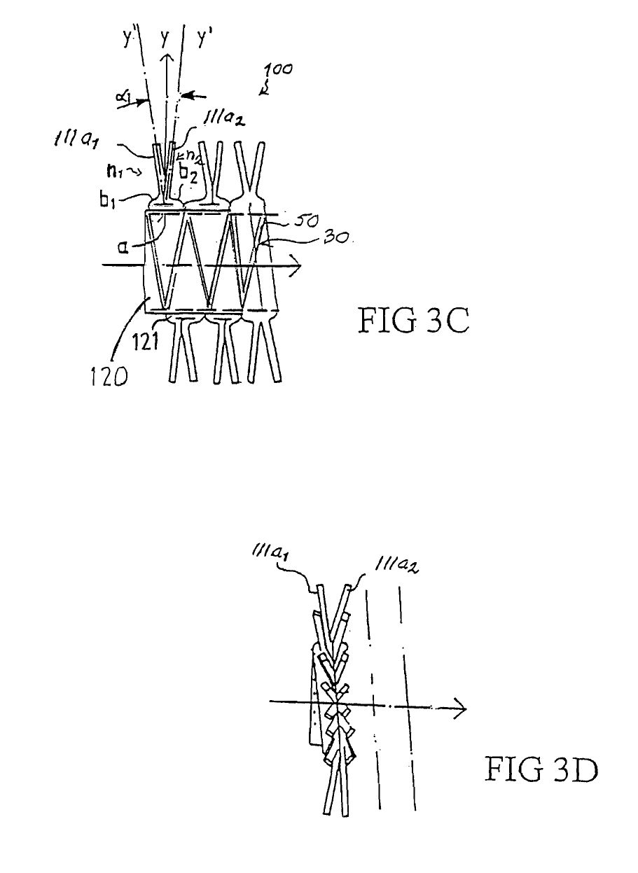

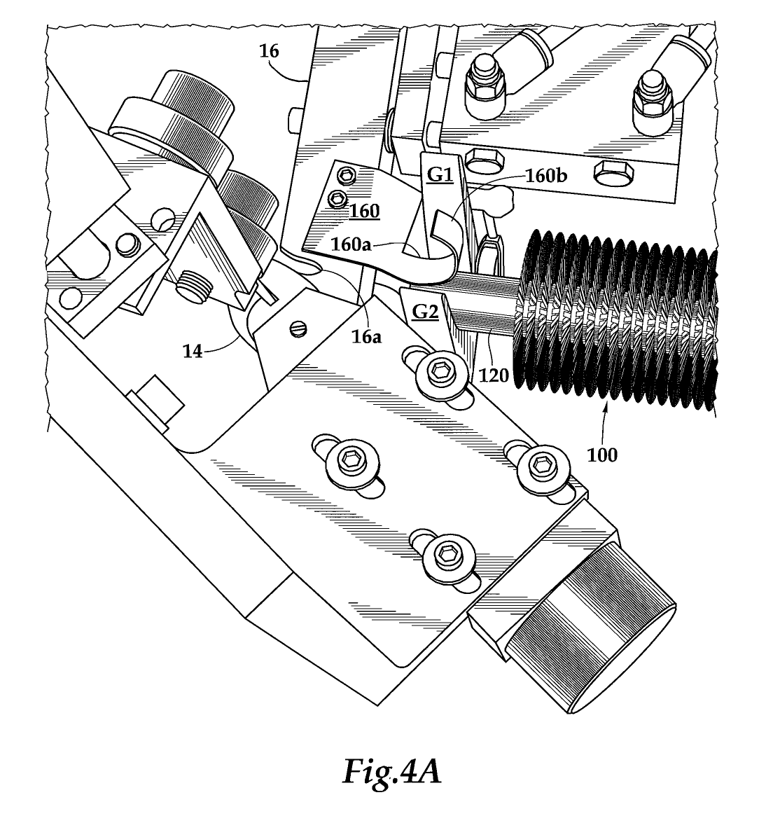

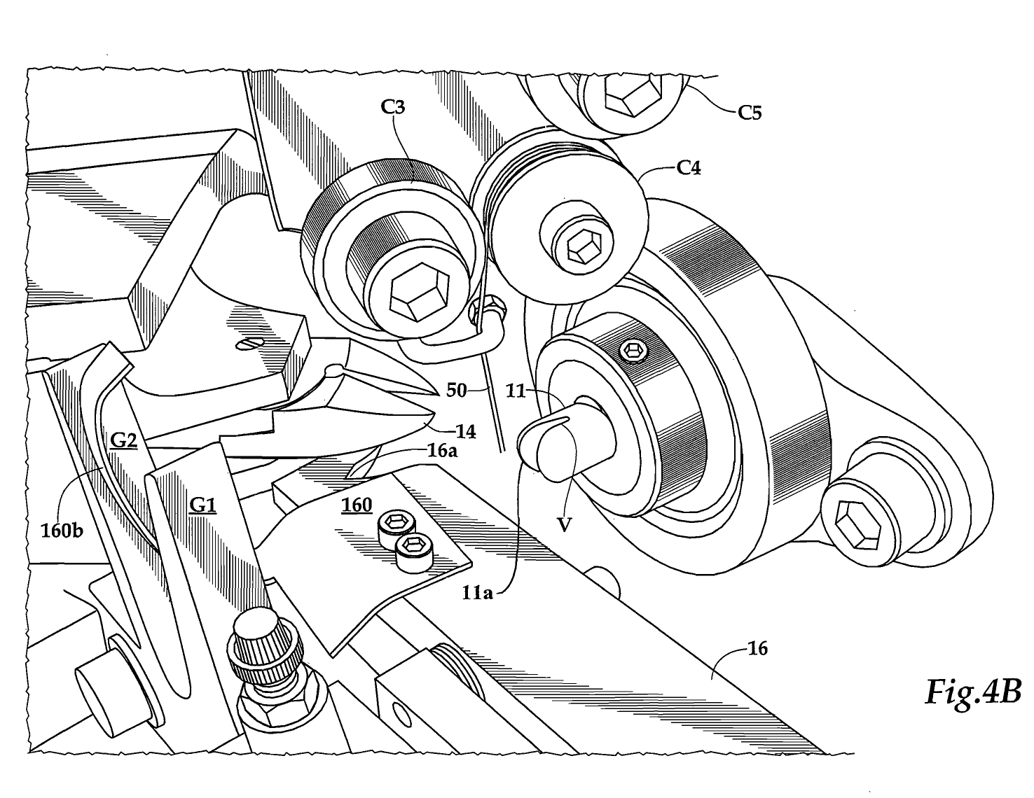

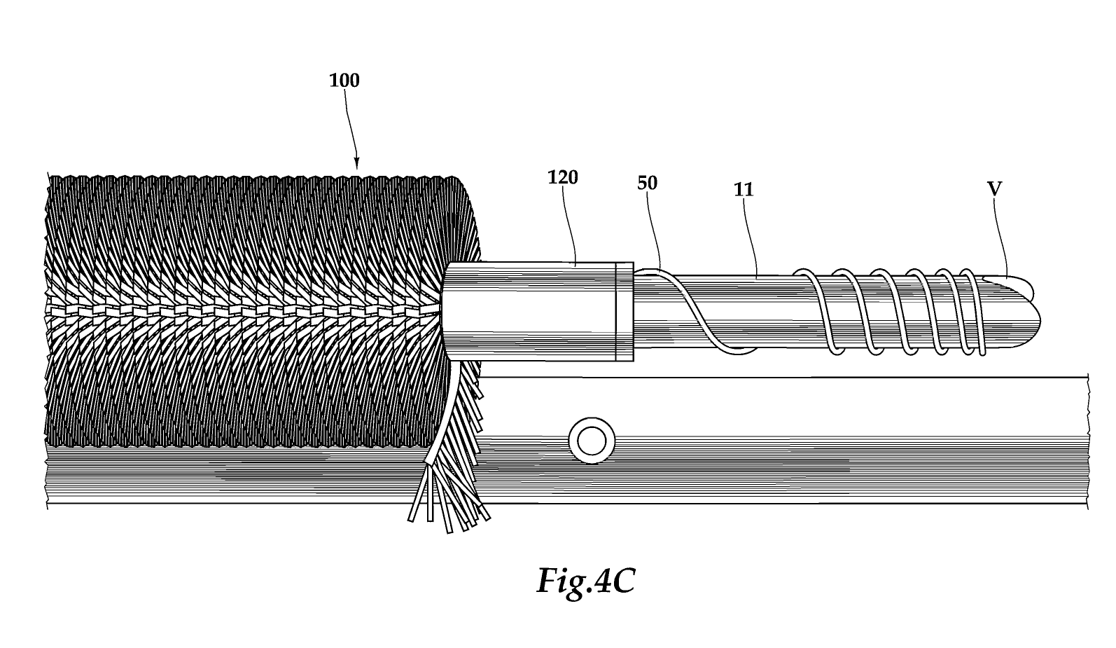

FIG. 1A is an illustrating view of equipment 10 used in the making of a so-called turbulence tube according to the invention. A body R₁ comprises a motor M₂, shown in FIG. 1B, whose driving wheel 18 is connected to a toothed bar T₂, whereby the body R₁ is moved on guide bars T₁ as shown in FIG. 1B. As shown in FIG. 1C, body R₁ has rotating equipment M₁, H₁, N₁, N₂ . . . for rotating the bar 11 in each fin-making station 10a₁, 10a₂ . . . and it rotates the bar. In this manner the bar 11 is moved forward and it is being rotated. In accordance with the invention, the equipment 10 in a needle-fin tube 100 in tube 120 mechanically and automatically makes internal fins 30, which are formed of a wire 50 and which circulate spirally inside the tube stretch 120, shown in FIG. 2A, of needle-fin tube 100 from one end to the other of the tube 120 for a heat carrier, and which is attached to its inside surface under its own spring force without any separate attaching means. According to the invention, the needle-fin tube structure 100 comprises a heat carrier tube 120, on the surface of which a fin strip 121, shown in FIG. 3C is wound, which fin strip 121 comprises two needle-fin rows N₁, N₂, wherein opposite needle-like fins 111a₁, 111a₂ . . . are at an acute angle α₁ in relation to one another. In addition, the needle fins 111a₁, 111a₂ . . . are rectangular structures comprising a surface deviating the flow. At their planar surfaces they are mutually at different angles, which is achieved by drawing the needle-fin strip into contact with a surface of the heat carrier tube 120. In accordance with the invention, after the winding the spirally and mechanically wound wire 50, shown in FIG. 4C, is released from the feeding bar 11, whereupon the wire 50 is wound and taken inside the tube 120. The wire 50 preferably has a round cross-sectional shape and is preferably a metal wire. According to the invention, fins having the desired pitch are formed with the aid of a machine according to the invention by regulating the feeding speed and/or the speed of rotation of the bar 11.

FIG. 1B illustrates the body R₁ from the direction of arrow K₁ of FIG. 1A.

FIG. 1C is an illustrating view of driving wheels N₁, N₂ . . . , which are used on belt H₁ and which rotate the bar of each fin-making station. Thus, one and the same motor M₁ can be used to rotate all bars 11 at the same time.

FIG. 1D shows a station A1, where the bar 11 is fed forward and it connects with a wire 50, whereby the wire 50 can be wound spirally around the bar 11 and the bar 11 can be moved forward by feeding it inside a heat carrier tube 120 of a needle-fin tube 100 brought into station A2.

As shown in an illustrating manner in the figures, for forming an internal, spirally extending fin 30 the equipment 10 comprises adjacent machine units 10a₁, 10a₂ . . . in fin-making stations P₁, P₂ . . . , which are similar to one another. Thus, the same equipment 10 can be used for making fins in several tubes 120 at the same time. According to the invention, the fin-making takes place with the aid of a bar 11 or feeding bar (a so-called “rassi”), which is rotated and moved in a linear manner inside a tube 120 of a needle-fin tube 100. The bar 11 at its one end comprises a notch V, into which the fin wire 50 is guided. When the wire 50 has been moved into notch V at one end 11a of the bar or feeding bar 11, shown in FIG. 4B, the feeding bar 11 is rotated, whereby the wire 50 will be wound on to the surface of feeding bar 11.

When the wire 50 is moved into notch V of the feeding bar 11, the wire 50 is supported with the aid of a support rod 16, and the support rod 16 has portion forming a notch 16a, to the bottom of which the wire 50 will arrive at the initial stage of feeding.

As shown in the FIG. 1D, the bar or feeding bar 11 or fin-making bar is rotated in the direction of arrow S₁ in a clockwise direction at the early stage of feeding with the aid of motor M₁ as the motor M₁ is driving a toothed belt H₁, which is placed through guiding and driving wheels N₁, N₂ . . . , such as by way of the driving wheel N₁ located at the end of the feeding bar 11. With the aid of the same belt H₁ and motor M₁ it is thus possible to rotate several feeding bars 11 in adjacent stations P₁, P₂, P₃ . . . and machine units 10a₁, 10a₂, 10a₃ . . . The feeding bar's 11 driving equipment M₁, H₁, N₁, N₂ . . . Nn is located at the end body R₁. The end body R₁ is moved carried by guide bars T₁ and it is supported by wheels O on the guiding bars T₁. Guiding bar T₁ is preferably a round bar and there can be, for example, two of these in the equipment. According to the invention, the body R₁ comprises an electrically operating motor M₂, which is adapted to connect with a toothed bar T₂ at its driving wheel 18 and thus to move the body R₁ and the bars, that is, the feeding bars 11 connected to it as the feeding is taking place.

In accordance with the invention, the bars 11 can be supported by supporting rollers or wheels Ö in auxiliary bodies R₂ as shown in FIG. 1A. The height position of support rollers Ö can be adjusted by a cylinder device. At a distance from the point where the feeding starts, there is a fixed body R₃, in which reels K₁, K₂ . . . for the fin wire 50 are located. The wire 50 for use in the fin-making is fed from the reels K₁, K₂ . . . in the adjacent stations P₁, P₂ . . . into each machine unit 10a₁, 10a₂ . . . . The support body R₃ comprises an auxiliary body R₄, shown in FIG. 1D which can be moved vertically as shown by arrows L₂ in relation to body R₃ and which comprises guiding wheels C₁, C₂, C₃ and C₄ and a wire brake C₅ for the wire 50, shown in FIG. 2B. The wire 50 is thus taken through the nip between the guiding wheels C₁ and C₂ and further to the wire brake C₅ and from this further into the nip between the guiding wheels C₃ and C₄ and further downwards. The wire 50 is hereby straightened in the nips as it arrives from a reels such as K1 and K2. The wire 50 is fed to be in front of the end 11a of feeding bar 11 by moving the auxiliary body R₄ in relation to body R₃ by the cylinder device 13 shown in FIG. 1A. At the lower station of body R₃ there is a body part R₅, see also FIG. 2C, which can be moved by an actuator 15 and in which there is a cutter 14, which is moved by the actuator 15, such as a cylinder device, in direction L₃, whereby the cutter 14 is brought into connection with the wire 50 and it can be used for performing the cutting motion S₂ shown in FIG. 2C by moving the jaw 14a of the scissors by the actuator 14c, such as a pneumatic cylinder, against the spring force of spring J₁₀.

In FIG. 1D the wire 50 feeding stage R₄ moves (arrow L₂) the wire 50 into the notch V in the end 11a of bar 11, the wire 50 is taken to the lower station A1. With the support rod 16 shown in FIG. 1E, 4A, and 4B, and brought to the station A1 with the aid of notch 16a, the wire 50 is supported on the bottom of the slot or notch V of bar 11 as feeding of the wire 50 is started.

Said position A1 is also the forward position of the support rod 16, and when the wire 50 has been fed into notch V in the end 11a of feeding bar 11, rotation (arrow S₁) and moving in a linear direction of the bar 11 are started as shown by arrow L₁ in FIG. 1A, forward into the tube part 120 of the needle-fin tube 100. The support rod 16 can then be moved to a forward position A2, whereby a curved supporting part 160 in the support lever 16 is brought against the surface of the needle-fin tube's 100 tube part 120 and it is supported thereon by its spring force. Thus, at the station A2 the support part 160 is used to support the needle-fin tube 100 during the feeding event. The support rod 16 can be moved as shown in FIG. 1E by an actuator 17, such as a cylinder device, from station A1 to station A2 and vice versa. At the station A2 the support part 160 is used to support the end of tube 120 as the tube 120 is located at its end in the guides G₁, G₂ shown in FIG. 2A and 4A.

As illustrated in FIG. 2D, the equipment 10 further comprises moving equipment 20 for the needle-fin tubes 100, which equipment in body R₆ comprises gripping parts 21a₁, 21a₂ . . . and in these jaw parts 23, 24, which are operated by a cylinder device and which are used for gripping the needle-fin tube 100 in order to move it to the station P₁, P₂ . . . where the internal fins 30 are made. At the same time it is a purpose of the device's 20 gripping parts 21a₁, 21a₂ . . . to hold on to the needle-fin tubes 100 during the internal fin-making as the spiral and helical internal fin 30 shown in FIGS. 3B and 3C, is being formed.

FIG. 2A shows a separate view of the support rod's support part 160. The support part 160 comprises a downward-extending curved stretch 160a, the outer surface of which will be located against the outer surface of the needle-fin tube's 100 tube part 120. The support part 160 also comprises an upward-extending stretch 160b. The curved part 160 works with its spring force and it is kept under force against the top surface of tube 120, whereby the end of tube 120 is supported.

FIG. 2B illustrates a wire-feeding station in body R₄, which is moved by an actuator 13 in relation to body R₃. The wire 50 travels through support rollers C₁, C₂, C₃, C₄ and a brake wheel C₅, and the purpose of support rollers C₁, C₂, C₃, C₄ is to straighten the wire 50 as it is being released from reel K, where it is located as a coil.

FIG. 2C illustrates the action of cutter 14. One scissors part 14a is moved by an actuator 14c against the spring force of spring J₁₀ whereas the other scissors-half 14b is in a fixed position. The cutter 14 is in the body R₅ and it is moved by actuator 15 into cutting station A1 and out of it.

FIG. 2D illustrates a transfer device 20 for the needle-fin tubes 100. The transfer device 20 comprises a body R₆, which is moved by actuators downwards and upwards (not shown) and in lateral directions. The transfer device 20 comprises gripping parts 21a₁, 21a₂ . . . and in these actuators, with which the jaws 22, 23 of the gripping parts 21a₁, 21a₂ . . . are opened and the fin tubes 100 are gripped and several needle-fin tubes 100 are moved at the same time into the fin-making stations P₁, P₂ . . . to end up in between guiding slots G₁, G₂ located therein as shown in FIGS. 2A, 4A, and 4B.

FIG. 3A shows a needle-fin tube 100 according to the invention. FIG. 3B is a cross-sectional view along line III-III of FIG. 3A, and FIG. 3C shows a fin strip as a cross-sectional view along line IV-IV of FIG. 3B. FIG. 3D shows the structure in the direction of arrow K, of FIG. 3B. As shown in FIGS. 3A, 3B, 3C and 3D, the needle-fin tube solution 100 comprises a central tube 120, to which the fin strip 121 is joined by winding and gluing it around the tube 120.

As shown in FIGS. 3A-3D, the needle-fin strip 121 has two adjacent needle rows n1 and n2, wherein the opposite needle fins 111a₁, 111a₂ are at an acute angle a1 in relation to one another. Said angle α₁ is an acute angle, whereby impurity particles will remain attached in different height positions in between adjacent fins 111a₁, 111a₂. The needle-fin tube 100 works both as a filter and as a heat exchanger. Heat can be transferred through it from the heat carrier made to flow inside tube 120 through the needle fins 111a₁, 111a₂ . . . into the air or heat can be transferred in the opposite direction from the air from flow L₁₀ through the needle fins 111a₁, 111a₂ . . . into the tube's 32 central heat carrier made to flow therein, whereby the airflow L₁₀ is being cooled. Both purposes of use are possible. The fin strip 121 comprises a base part and folded covering parts b₁ and b₂, to which the needle fins 111a₁, 111a₂ . . . are joined. Thus, the needle-fin tubes 100 can be used in the manner shown in FIG. 3E. The needle-fin tubes 100 are formed as a filter wall 12, whereby a heat carrier is conducted from manifold J₁ into the needle-fin tube 120 of each wall 12 and the heat carrier is removed from the manifold J₂. The wall 12 forms a pre-filter, a so-called rough filter, and a heat exchanger, whereupon the equipment comprises a fine filter, which can be used for removing impurity particles of a smaller particle size from the air after the pre-filtration.

FIG. 3C shows fins 30 and a fin wire 50 according to the invention inside a tube 120. The fins 30 have been made by using the equipment and method described in the foregoing.

FIG. 4A shows the initial station A1 of fin-making, in which feeding of the wire 50 forming the fin 30 is started into the heat carrier tube 120 of the needle-fin tube 100. The wire 50 is guided from the nip between wheels C₃ and C₄, shown in FIG. 4B.

FIG. 4A shows in particular a support rod 16 and a slot, such as a V notch 16a therein, with the aid of which the wire 50 is supported as it is taken into the notch V in the end 11a of bar 11, shown in FIG. 4B.

FIG. 4B shows a station such as A1 corresponding to FIG. 4A from a different direction. The needle-fin tube 100 is not yet in the station.

FIG. 4C shows the final stage of fin-making, wherein the bar 11 leaves the end of tube 120 and the wire 50 has not yet been released from the slot V. The release will take place by changing the direction of rotation of bar 11.

For controlling the equipment according to the invention several sensor devices are used to determine the motion positions and to synchronize the inter-related operations of the actuators. For example, the speed of rotation of the bar's 11 rotating device can be controlled by step-less control and/or the feeding speed of the bar's 11 linear motion can also be controlled in a linear manner, and said speeds can be measured with the aid of sensors in order to achieve the correct control. An optimum transfer of heat from the heat carrier to the fins of the needle-fin tube or in the opposite direction is achieved in this manner, and the heat transfer is dependent on the operating conditions at each time and also, for example, on the pressure and temperatures of the liquid.

I claim:

1. A method in making a needle-fin tube having an internal fin structure comprising the steps of:
starting with a needle-fin tube having needle-like fin parts wrapped around a tube for a heat carrier liquid, placing within the tube an internal fin structure in the form of a spiral wire which is elastically biased against an inner wall defined by the tube;
wherein a wire is brought to releasably attach to a cylindrical bar, which bar is rotated to wind the wire about the bar and linearly transferred while rotating to form thereon the spiral wire as a spring wound along the bar and attached to the bar;
wherein the spiral wire wound along the bar and attached to the bar is moved inside the tube so the spiral wire wound along the bar extends from a first end to a second opposite end of the tube; and
wherein the spiral wire is wound along the bar and is released from the bar to attach to the inside surface of the tube under a self-generated spring force.

2. The method of claim 1 wherein the wire is brought from a wire reel to a notch at one end of the cylindrical bar, and wherein the cylindrical bar is rotated, whereby the wire is attached to said one end of the bar, and that the bar is moved in a linear manner inside the tube and the cylindrical bar is rotated at the same time.

3. The method of claim 2 wherein in the method the wire is brought from the reel by way of wheels, which maintain a selected tension in the wire, and the wire is taken into the notch in one end of the bar and it is moved to the bottom of the notch with the aid of a support rod.

4. The method of claim 3 wherein the support rod is moved to a position where it holds the needle-fin tube with a counter part having an elastic curved downward-extending counter stretch and an upward-extending counter stretch, the counter part being mounted to the support bar and holding the needle-fin tube in place with a spring force in the curved downward-extending counter stretch.

5. The method of claim 4 wherein the support rod is taken from a first station to a second station, in which the elastic curved downward-extending counter stretch supports the needle-fin tube and in which first station the transfer of the wire into the notch in the end of bar is supported.

6. The method of claim 1 wherein a round wire is formed into the spiral wire which is elastically biased against the inner wall defined by the tube.

7. The method of claim 1 wherein during the formation of the internal fin structure in the form of a spiral wire the needle-fin tube is supported in jaws of a transfer device which holds the needle-fin tubes while the internal fin structure is being formed.

8. The method of claim 1 wherein in the method several adjacent needle-fin tubes are formed simultaneously, and a motor and belt drive rotates several cylindrical bars at the same time, and wherein a body to which the motor and belt drive is mounted is moved in a linear manner in order to move a plurality of internal fin structures, each in the form of a spiral wire, at the same time inside the adjacent needle-fin tubes.

9. The method of claim 1 wherein when the wire has been guided inside the tube of the needle-fin tube the wire is cut off by a cutter.

10. The method of claim 1 further comprising monitoring the different stages of forming the internal fin structure with sensor devices.

11. The method of claim 1 wherein the cylindrical bar speed of rotation is adjusted and changed and likewise the speed of the bar linear motion is adjusted and changed to control the pitch of the spiral wire in its spiral and helical travel.

12. An apparatus for making an internal fin in a needle-fin tube comprising:
an internal fin making station, the fin making station further comprising:
an elongated bar having a notch at one end, the bar mounted for rotation about an axis and at the same time mounted for linear motion along the axis;
equipment for rotating the bar;
equipment for moving the bar in a linear manner inside a tube of a needle-fin tube;
a reel of wire, the wire extending through a guiding device, the guiding device having a plurality of guide rollers, through which the wire extends so that the wire is arranged to be guided through nips formed between guide rollers of the plurality of guide rollers;
a support rod mounted for motion between a first station and a second station, the support rod having portions defining a notch or slot, the support rod supporting the wire in the notch or slot in the first station and supporting the needle-fin tube in the second station with a structure mounted to the support rod comprising a curved downward-extending structure and an upward-extending a structure, the structure arranged to engage the needle-fin tube during the fin-making;
an actuator for moving the support rod between the first station and the second station; and
a cutter arranged to cut off the wire when actuated and positioned to cut off the wire in the second station.

13. The apparatus of claim 12 further comprising:
a device for transferring needle-fin tubes, in which device there are gripping jaws arranged to grip needle-fin tubes, and which device is arranged to move needle-fin tubes from an initial station, and to hold needle-fin tubes to the internal fin making station and further arranged to grip and move needle-fin tubes forward after completion of an internal fin in a needle-fin tube.

14. The apparatus of claim 12 wherein the equipment for rotating the bar is mounted to a body and the equipment for moving the bar in a linear manner is mounted to the body to move the body in a linear manner, so that the bar can be both rotated and moved in a linear manner at the same time.

15. The apparatus of claim 12 further comprising
a plurality of internal fin making stations, each internal fin making station having an elongated bar having a notch at one end, each elongated bar being mounted for rotation about an axis to a body and an actuator mounted to the body for moving a belt connected to a plurality of drive wheels, each drive wheel mounted to one of said plurality of elongated bars so that the plurality of bars can be driven together.

16. The apparatus of claim 15 further comprising an actuator mounted to the body for moving the body, whereby the plurality of elongated bars are moved at the same time in a linear manner by said actuator.

17. The apparatus of claim 16 further comprising supporting rollers in each internal fin making station for supporting each of the elongated bars therein.

18. The apparatus of claim 12 further comprising a needle-fin tube having an interior spiral fin formed of a wire, the interior spiral fin attached to an inside wall of the tube of the needle-fin tube by a spring force inhering to the interior spiral fin.

20. The apparatus of claim 18 wherein the interior spiral fin is formed of a wire which is a metal wire.

21. The apparatus of claim 20 wherein the wire has a circular cross-section.
